(19) United States
(12) Patent Application Publication
(10) Pub. No.: US 2024/0053502 A1
(43) Pub. Date: Feb. 15, 2024

(54) TOC Prediction Method for Shale Gas Reservoirs

(71) Applicant: Southwest Petroleum University, Chengdu City (CN)

(72) Inventors: Jianhua Dong, Chengdu City (CN); Lei Chen, Chengdu City (CN); Xiucheng Tan, Chengdu City (CN); Min Xiong, Chengdu City (CN); Tangxuan Liu, Chengdu City (CN)

(73) Assignee: Southwest Petroleum University, Chengdu City (CN)

(21) Appl. No.: 18/494,921

(22) Filed: Oct. 26, 2023

(30) Foreign Application Priority Data
Oct. 27, 2022 (CN) 202211325644.9

(51) Int. Cl. G01V 1/50; E21B 49/00

(52) U.S. Cl. CPC G01V 1/50; E21B 49/00; G01V 2210/512; G01V 2210/514; G01V 2210/622; E21B 2200/20

(57) ABSTRACT

The present disclosure provides a TOC prediction method for shale gas reservoirs, including: determining by well-seismic calibration a top interface Tₜₒₚ and a bottom interface T_{bottom} of the shale gas reservoirs, and performing layer tracking in the entire area; converting the pre-stack CRP gather into angle gather seismic data; performing spectral shaping processing on the pre-stack migration pure wave seismic data; establishing an initial model, and then performing pre-stack simultaneous inversion to obtain P-wave impedance, S-wave impedance, primary-to-shear wave velocity ratio and density data volume; obtaining a TOC inversion volume A through a post-stack inversion; obtaining a TOC inversion volume B by calculation; then adding the well data for correction, and finally determining a planar distribution law of TOC content. The method can eliminate the multiple solutions of pre-stack inversion and improve the accuracy of TOC content prediction of shale.

### CROSS-REFERENCE TO RELATED APPLICATION

This application claims priority to Chinese Patent Application No. 202211325644.9, filed on Oct. 27, 2022 before the China National Intellectual Property Administration, the disclosure of which is incorporated herein by reference in entirety.

### TECHNICAL FIELD

The present disclosure relates to the field of geological technology, and in particular to a TOC prediction method for shale gas reservoirs.

### BACKGROUND

The TOC content of shale gas reservoirs is an important indicator for evaluating the organic matter characteristics of the reservoir, it has important guiding significance for the selection of sweet spots in shale gas reservoirs and plays a positive role in the storage space of the reservoir. The Chinese patent application with application number CN202010678919.1 and title of “Pre-stack quantitative prediction method, device and equipment for total organic carbon content in shale gas reservoirs” discloses a pre-stack quantitative prediction method for total organic carbon content in shale gas reservoirs. The method includes: obtaining pre-processed pre-stack angle gather data of shale gas reservoirs; generating a low-frequency model of near-angle, mid-angle, and far-angle elastic wave impedance of the shale gas reservoirs based on the pre-processed pre-stack angle gather data, calibrated time-depth relationship and seismic layer interpretation data; performing inversion on the low-frequency model to obtain inversion results; determining a primary-to-shear wave velocity ratio of the shale gas reservoirs based on the inversion results; inputting the primary-to-shear wave velocity ratio to a preset relationship curve between the primary-to-shear wave velocity ratio and TOC content to obtain the TOC content of the shale gas reservoirs.

However, since this method uses the pre-stack elastic wave impedance inversion method, the obtained inversion results cannot be directly analyzed with the TOC content of the shale, it needs to indirectly calculate the data volume of primary-to-shear wave velocity ratio, thus increasing the probability of error of the inversion.

### SUMMARY

The purpose of the present disclosure is to solve the above-mentioned defects in the prior art and provide a TOC prediction method for shale gas reservoirs.

A TOC prediction method for shale gas reservoirs, comprising:
step 1: obtaining well data, seismic data, and velocity data, the well data comprising sonic transit time curve DTC, shear wave transit time curve DTS, volume density curve DEN, and TOC curve; the seismic data comprising pre-stack CRP gather, pre-stack migration pure wave seismic data and post-stack result data volume; the velocity data comprising stacking velocity volume or root mean square velocity volume;
step 2: determining by well-seismic calibration a top interface Tₜₒₚ and a bottom interface T_{bottom} of the shale gas reservoirs in a study area according to the post-stack result data volume, and performing layer tracking in the entire area;
step 3: converting the stacking velocity volume or root mean square velocity volume into a layer velocity volume, and converting the pre-stack CRP gather into angle gather seismic data by using the layer velocity volume;
step 4: eliminating random noise and linear interference of the pre-stack CRP gather through a prediction-elimination-denoising method, and performing super-gather processing on the CRP gather after prediction, elimination and denoising, to improve its signal-to-noise ratio;
step 5: performing gather flattening processing on the CRP gather after elimination and denoising to eliminate its remaining time difference; performing spectral shaping processing on the pre-stack migration pure wave seismic data to maintain low frequencies, and expanding high frequency components to improve a resolution ratio of the seismic data, performing parameter correction by using a synthetic recording method at the end of the spectral shaping processing, processing results having a good correspondence with synthetic seismic records;
step 6: performing well-seismic calibration based on the well data and the angle gather seismic data, establishing a time-depth relationship on the well, and then extracting near, medium and far angle wavelets, and then establishing an initial model of primary wave impedance, an initial model of shear wave impedance, an initial model of density, and then performing pre-stack simultaneous inversion to obtain P-wave impedance, S-wave impedance, primary-to-shear wave velocity ratio and density data volume; using a wavelet frequency division method to divide the pre-stack migration pure wave seismic data by 10 Hz intervals into a data volume having discrete frequencies of 10 Hz, 20 Hz, 30 Hz, 40 Hz, 50 Hz and 60 Hz, establishing a fitting relationship between a logging TOC content curve and the seismic data based on a support vector machine SVM training, and finally obtaining a TOC inversion volume A through a post-stack inversion;
step 7: selecting a primary-to-shear wave velocity ratio curve and the TOC content curve to establish a linear fitting formula, and obtaining a TOC inversion volume B by calculation;
step 8: performing stratigraphic slicing on the TOC inversion volume A and TOC inversion volume B respectively, then adding the well data for correction, and finally determining a planar distribution law of TOC content in the study area.

According to some embodiments of the present disclosure, the step of “performing pre-stack simultaneous inversion to obtain P-wave impedance, S-wave impedance, primary-to-shear wave velocity ratio and density data volume” described in the step 6 comprises:
step 1: establishing an initial model by using the angle gather seismic data and the well data with well-seismic calibration completed;
step 2: giving a gamma value of the area by using the angle gather seismic data and the initial model based on a result of well statistics, the gamma value being a ratio of a shear wave velocity curve vs to a primary wave velocity curve vp;
step 3: performing parameter testing by an inversion parameter testing module using an initial model curve on the well, an inversion result curve, and seismic data results of a forward gather and an actual angle gather next to the well;
step 4: by continuously adjusting parameters, minimizing a difference between a solution obtained and the forward gather next to the well, and finally completing an output to obtain the P-wave impedance, S-wave impedance, primary-to-shear wave velocity ratio and density data volume.

According to some embodiments of the present disclosure, the fitting formula in the step 7 is: TOC=12.624−5.8975*vp/vs;

the TOC inversion volume B is obtained by: using the formula TOC=12.624−5.8975*vp/vs to convert the primary-to-shear wave velocity ratio into the TOC inversion volume B.

### Beneficial Effects

The method provided by the present disclosure can simply and quickly use well data and seismic data to predict the distribution law of TOC content of shale in a certain area. By using the method of mutual verification of pre-stack simultaneous inversion technology and SVM-based post-stack inversion, it can reduce and eliminate the multiple solutions in the prediction of TOC content of shale, and improve the accuracy of the prediction of TOC content of shale. This method improves the prediction method of TOC content of shale and is helpful for the later research of the depositional environment and the heterogeneity of reservoir performance of shale, and then can determine the thickness and development location of high-quality shale reservoirs, provide a basis for the selection of favorable target areas in the shale gas exploration process, and accelerate the exploration breakthrough of shale gas.

### BRIEF DESCRIPTION OF THE DRAWINGS

FIG. 1 is a flow chart of the TOC prediction method for shale gas reservoirs of the present disclosure;

FIG. 2 is a schematic diagram of comparison and tracking of the top and bottom interfaces of shale gas reservoirs;

FIG. 3 is a schematic diagram of pre-stack CRP gather optimization processing;

FIG. 4 is a comparison chart before and after spectral shaping processing of pre-stack migration pure wave seismic data;

FIG. 5 is a schematic diagram of angle gather seismic data;

FIG. 6 shows an initial model of pre-stack simultaneous inversion;

FIG. 7 shows results of pre-stack simultaneous inversion;

FIG. 8 is a schematic diagram of the discrete frequency data volume;

FIG. 9 is a schematic diagram of SVM training results and correlation coefficients;

FIG. 10 is a schematic diagram of sensitive parameter optimization;

FIG. 11 is a schematic diagram of the inversion TOC volume slice.

### DETAILED DESCRIPTION OF EMBODIMENTS

In order to make the purpose, technical solutions and advantages of the present disclosure clearer, the technical solutions in the present disclosure will be described clearly and completely below. Obviously, the described embodiments are only a part of the embodiments of the present disclosure, rather than all the embodiments. All other embodiments obtained by those of ordinary skill in the art based on the embodiments of the present disclosure without creative efforts fall within the scope of protection of the present disclosure.

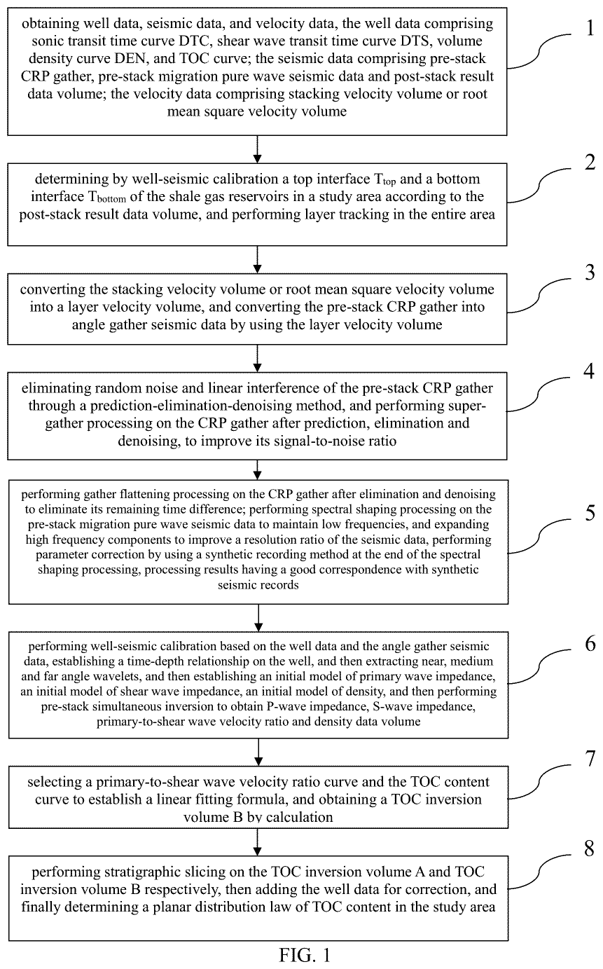

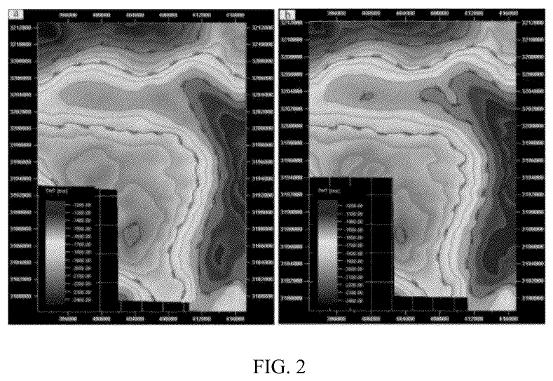

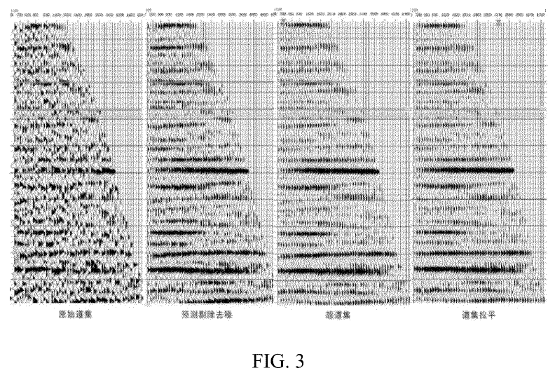

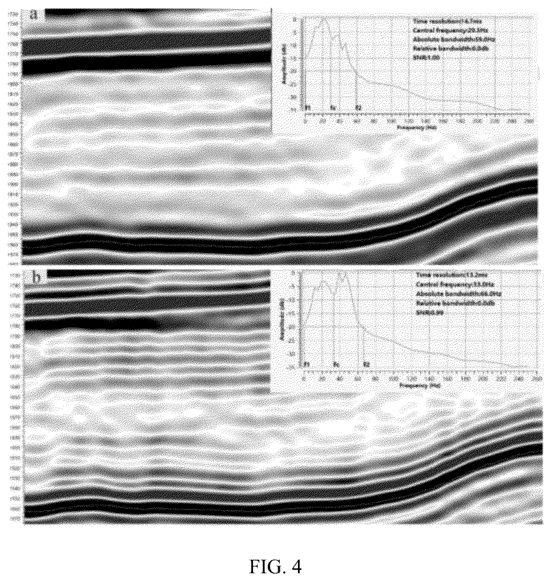

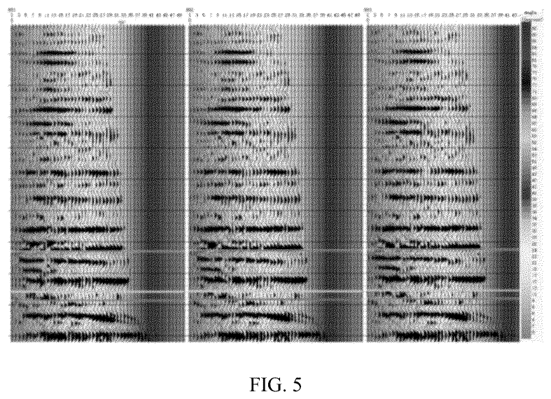

FIG. 1 is a flow chart of the TOC prediction method for shale gas reservoirs of the present disclosure. As shown in FIG. 1, the method includes the following steps:
Step 1: obtaining well data, seismic data, and velocity data, the well data comprising sonic transit time curve DTC, shear wave transit time curve DTS, volume density curve DEN, and TOC curve; the seismic data comprising pre-stack CRP gather, pre-stack migration pure wave seismic data and post-stack result data volume; the velocity data comprising stacking velocity volume (stacking velocity body) or root mean square velocity volume (root mean square velocity body);
Step 2: determining by well-seismic calibration a top interface Tₜₒₚ and a bottom interface T_{bottom} of the shale gas reservoirs in a study area according to the post-stack result data volume, and performing layer tracking in the entire area; FIG. 2 is a schematic diagram of comparison and tracking of the top and bottom interfaces of shale gas reservoirs, as shown in FIG. 2, a is Tₜₒₚ, b is T_{bottom}.
Step 3: converting the stacking velocity volume or root mean square velocity volume into a layer velocity volume, and converting the pre-stack CRP gather into angle gather seismic data by using the layer velocity volume; as shown in FIG. 5 it shows the converted angle gather seismic data.
Step 4: eliminating random noise and linear interference of the pre-stack CRP gather through a prediction-elimination-denoising method, and performing super-gather processing on the CRP gather after prediction, elimination and denoising, to improve its signal-to-noise ratio;
Step 5: performing gather flattening processing on the CRP gather after elimination and denoising to eliminate its remaining time difference; performing spectral shaping processing on the pre-stack migration pure wave seismic data to maintain low frequencies, and expanding high frequency components to improve a resolution ratio of the seismic data, performing parameter correction by using a synthetic recording method at the end of the spectral shaping processing, processing results having a good correspondence with synthetic seismic records; the pre-stack CRP gather optimization process is shown in FIG. 3. The comparison between before and after spectrum shaping processing of pre-stack migration pure wave seismic data is shown in FIG. 4, where a is before spectrum shaping and b is after spectrum shaping.
Step 6: performing well-seismic calibration based on the well data and the angle gather seismic data, establishing a time-depth relationship on the well, and then extracting near, medium and far angle wavelets, and then establishing an initial model of primary wave impedance, an initial model of shear wave impedance, an initial model of density, and then performing pre-stack simultaneous inversion to obtain P-wave impedance, S-wave impedance, primary-to-shear wave velocity ratio (longitudinal-to-transverse wave velocity ratio) and density data volume; using a wavelet frequency division method to divide the pre-stack migration pure wave seismic data by 10 Hz intervals into a data volume (data body) having discrete frequencies of 10 Hz, 20 Hz, 30 Hz, 40 Hz, 50 Hz and 60 Hz, establishing a fitting relationship between a logging TOC content curve and the seismic data based on a support vector machine SVM training, and finally obtaining a TOC inversion volume (TOC inversion body) A through a post-stack inversion.

Specifically, the specific implementation method of “performing pre-stack simultaneous inversion to obtain P-wave impedance, S-wave impedance, primary-to-shear wave velocity ratio and density data volume” includes the following steps:
Step I: establishing an initial model through Hampson Russell software by using the angle gather seismic data and the well data with well-seismic calibration completed;
Step II: inputting the angle gather and initial model in Hampson Russell software, and giving a gamma value of the area based on the results of the well statistics (the gamma value is a ratio of curve vs to curve vp, vs is a shear wave velocity curve, vp is a primary velocity curve).
Step III: performing parameter testing by an inversion parameter testing module of Hampson Russell software using an initial model curve on the well, an inversion result curve, and results of a forward gather and an actual angle gather next to the well;
Step IV: by continuously adjusting parameters, minimizing a difference between a solution obtained and the forward gather next to the well, and finally completing an output to obtain the P-wave impedance, S-wave impedance, primary-to-shear wave velocity ratio and density data volume.

The specific implementation method of “finally obtaining a TOC inversion volume A through a post-stack inversion” includes the following steps:
Step I: Using Geoscope software to apply a wavelet frequency division technology to divide the pre-stack migration pure wave seismic data into data volumes with discrete frequencies of 10 Hz, 20 Hz, 30 Hz, 40 Hz, 50 Hz and 60 Hz;
Step II: Using the inversion module of Geoscope software to establish a fitting relationship between the logging TOC content curve and the seismic data based on support vector machine SVM training;
Step III: final calculating to obtain the TOC inversion volume A.

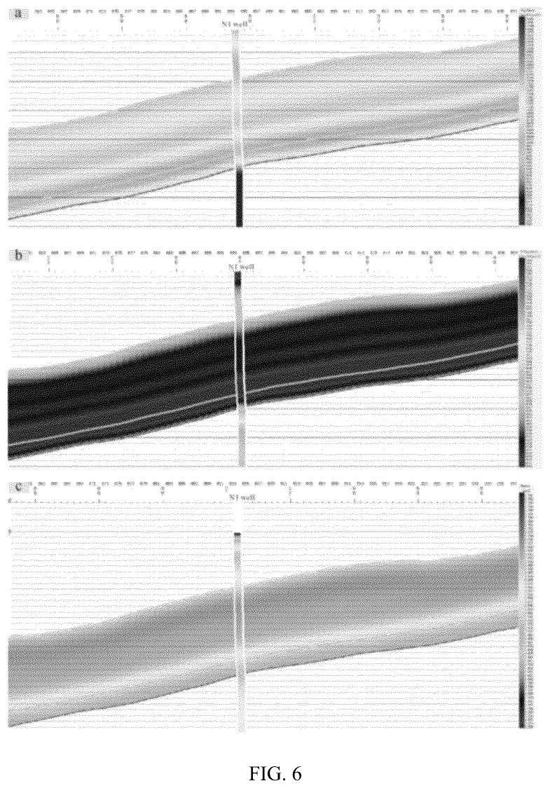

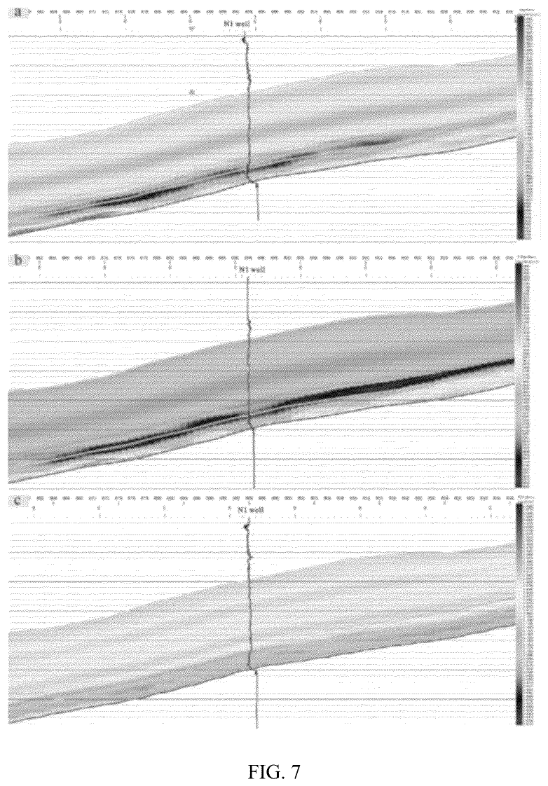

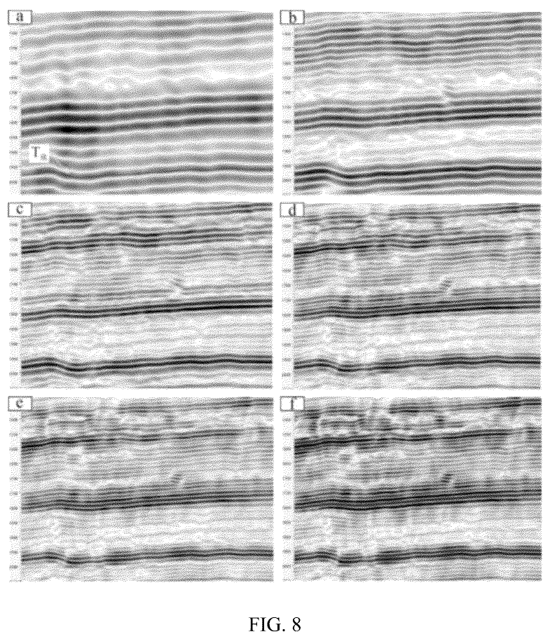

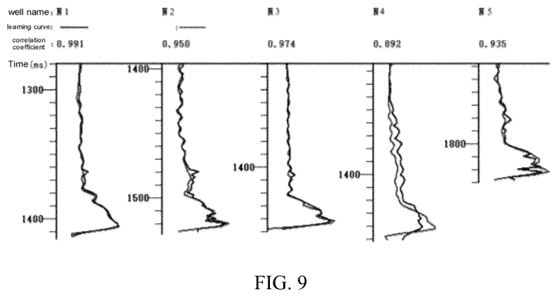

FIG. 6 is a schematic diagram of an initial model of pre-stack simultaneous inversion, where a is the initial model of primary (longitudinal) wave impedance, b is the initial model of shear (transverse) wave impedance, and c is the initial model of density. The discrete frequency data volume is shown in FIG. 7, where a is the primary wave impedance, b is the shear wave impedance, and c is the primary-to-shear wave velocity ratio. The SVM training results and correlation coefficients are shown in FIG. 8, where a is 10 Hz, b is 20 Hz, c is 30 Hz, d is 40 Hz, e is 50 Hz, and f is 60 Hz. The SVM training results and correlation coefficients are shown in FIG. 9.
Step 7: selecting a primary-to-shear wave velocity ratio curve and the TOC content curve to establish a linear fitting formula, and obtaining a TOC inversion volume B by calculation.

The fitting formula is: TOC=12.624−5.8975*vp/vs; calculating TOC inversion volume B includes: using the formula TOC=12.624−5.8975*vp/vs to convert the primary-to-shear wave velocity ratio into the TOC inversion volume B.

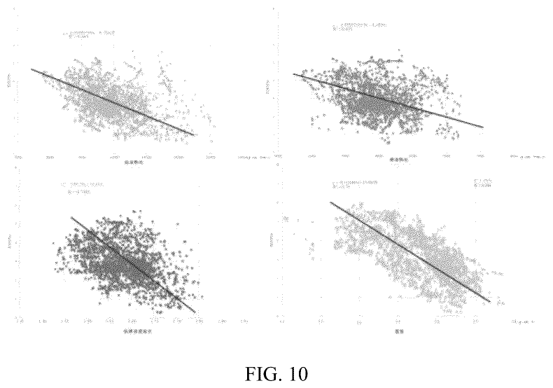

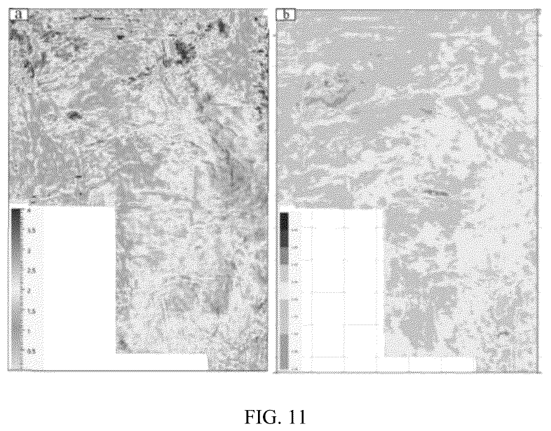

Specifically, the best sensitive parameters of primary wave impedance, shear wave impedance, primary-to-shear wave velocity ratio, and density and TOC content are selected. Since the inversion result of the density is unstable in the small angle range, finally the primary-to-shear wave velocity ratio and TOC content are selected to establish linear fitting formula to calculate the TOC inversion volume B. The preferred sensitive parameters are shown in FIG. 10.
Step 8: performing stratigraphic slicing on the TOC inversion volume A and TOC inversion volume B respectively, then adding the well data for correction, and finally determining a planar distribution law of TOC content in the study area. The inversion TOC volume slice is shown in FIG. 11, where a is post-stack inversion based on SVM, and b is pre-stack simultaneous inversion.

Specifically, the pre-stack simultaneous inversion solves the pre-stack angle gather based on the Fatti trinomial approximation equation. Since the pre-stack simultaneous inversion is a model-based inversion, the well data and extracted wavelet convolution are used to generate near wellbore forward seismic trace. During the solution process, by continuously comparing the obtained solution with the wellside forward gather, the residual between the two are minimized, and finally the output is completed to obtain the primary-wave impedance, shear-wave impedance, primary-to-shear wave velocity ratio and density. To establish the initial model is because the seismic data lacks low-frequency information. The initial model is established based on the low-frequency information on the well. Finally, the low-frequency initial model is added to the inversion process to supplement the low-frequency information missing in the inversion process and make the inversion results more reliable.

According to the method provided by the present disclosure a pre-stack simultaneous inversion method is used during the prediction process of TOC content of shale, the obtained inversion results can be directly analyzed with the TOC content of shale, thereby reducing errors in the shale TOC inversion process. Then a post-stack inversion is performed based on SVM, and SVM is used to establish a best fitting relationship between the logging TOC curve and seismic data (10 Hz˜60 Hz discrete frequency of seismic data and the P-wave impedance, S-wave impedance, P-S wave velocity ratio data volume obtained by the pre-stack simultaneous inversion), finally the TOC inversion volume is obtained based on the post-stack inversion of SVM. Using the mutual verification method of pre-stack simultaneous inversion and SVM-based post-stack inversion can reduce and eliminate the multiple solutions of the pre-stack inversion and improve the accuracy of the prediction of TOC content of shale.

Finally, it should be noted that the above embodiments are only used to illustrate the technical solutions of the present disclosure, but not to limit the present disclosure. Although the present disclosure has been described in detail with reference to the foregoing embodiments, those of ordinary skill in the art should understand that modifications can still be made to the technical solutions described in the foregoing embodiments, or equivalent substitutions can be made to some of the technical features. However, these modifications or substitutions do not cause the essence of the corresponding technical solutions to deviate from the spirit and scope of the technical solutions of the embodiments of the present disclosure.

What is claimed is:

1. A TOC prediction method for shale gas reservoirs, comprising:
step 1: obtaining well data, seismic data, and velocity data, the well data comprising sonic transit time curve DTC, shear wave transit time curve DTS, volume density curve DEN, and TOC curve; the seismic data comprising pre-stack CRP gather, pre-stack migration pure wave seismic data and post-stack result data volume; the velocity data comprising stacking velocity volume or root mean square velocity volume;
step 2: determining by well-seismic calibration a top interface Tₜₒₚ and a bottom interface T_{bottom} of the shale gas reservoirs in a study area according to the post-stack result data volume, and performing layer tracking in the entire area;
step 3: converting the stacking velocity volume or root mean square velocity volume into a layer velocity volume, and converting the pre-stack CRP gather into angle gather seismic data by using the layer velocity volume;
step 4: eliminating random noise and linear interference of the pre-stack CRP gather through a prediction-elimination-denoising method, and performing super-gather processing on the CRP gather after prediction, elimination and denoising, to improve its signal-to-noise ratio;
step 5: performing gather flattening processing on the CRP gather after elimination and denoising to eliminate its remaining time difference; performing spectral shaping processing on the pre-stack migration pure wave seismic data to maintain low frequencies, and expanding high frequency components to improve a resolution ratio of the seismic data, performing parameter correction by using a synthetic recording method at the end of the spectral shaping processing, processing results having a good correspondence with synthetic seismic records;
step 6: performing well-seismic calibration based on the well data and the angle gather seismic data, establishing a time-depth relationship on the well, and then extracting near, medium and far angle wavelets, and then establishing an initial model of primary wave impedance, an initial model of shear wave impedance, an initial model of density, and then performing pre-stack simultaneous inversion to obtain P-wave impedance, S-wave impedance, primary-to-shear wave velocity ratio and density data volume; using a wavelet frequency division method to divide the pre-stack migration pure wave seismic data by 10 Hz intervals into a data volume having discrete frequencies of 10 Hz, 20 Hz, 30 Hz, 40 Hz, 50 Hz and 60 Hz, establishing a fitting relationship between a logging TOC content curve and the seismic data based on a support vector machine SVM training, and finally obtaining a TOC inversion volume A through a post-stack inversion;
step 7: selecting a primary-to-shear wave velocity ratio curve and the TOC content curve to establish a linear fitting formula, and obtaining a TOC inversion volume B by calculation;
step 8: performing stratigraphic slicing on the TOC inversion volume A and TOC inversion volume B respectively, then adding the well data for correction, and finally determining a planar distribution law of TOC content in the study area.

2. The TOC prediction method for shale gas reservoirs according to claim 1, wherein, the step of “performing pre-stack simultaneous inversion to obtain P-wave impedance, S-wave impedance, primary-to-shear wave velocity ratio and density data volume” described in the step 6 comprises:
step 1: establishing an initial model by using the angle gather seismic data and the well data with well-seismic calibration completed;
step 2: giving a gamma value of the area by using the angle gather seismic data and the initial model based on a result of well statistics, the gamma value being a ratio of a shear wave velocity curve vs to a primary wave velocity curve vp;
step 3: performing parameter testing by an inversion parameter testing module using an initial model curve on the well, an inversion result curve, and seismic data results of a forward gather and an actual angle gather next to the well;
step 4: by continuously adjusting parameters, minimizing a difference between a solution obtained and the forward gather next to the well, and finally completing an output to obtain the P-wave impedance, S-wave impedance, primary-to-shear wave velocity ratio and density data volume.

3. The TOC prediction method for shale gas reservoirs according to claim 2, wherein the fitting formula in the step 7 is: TOC=12.624−5.8975*vp/vs;
the TOC inversion volume B is obtained by: using the formula TOC=12.624−5.8975*vp/vs to convert the primary-to-shear wave velocity ratio into the TOC inversion volume B.
